(19) United States
(12) Patent Application Publication
(10) Pub. No.: US 2012/0027323 A1
(43) Pub. Date: Feb. 2, 2012

(54) One Way Valve For Evacuating Air From Food Storage Bags

(76) Inventors: Nugent Vitallo, Oak Brook, IL (US); Mark Hasenberg, Kenosha, IL (US); Peter Monaghan, Burlington, WI (US)

(21) Appl. No.: 12/848,220

(22) Filed: Aug. 2, 2010

(51) Int. Cl. B65D 33/01; B32B 37/10; B65B 31/04

(52) U.S. Cl. 383/100; 53/432; 156/73.5

(57) ABSTRACT

A one way valve for exhaling or evacuating air from containers, such as storage bags for preserving food and other items. The one way valve device is attached or sealed airtight to the body of the bag's outer surface wherein the one way valve is centrally positioned over a hole created on the surface of the bag. The hole forms a passage for the air to be evacuated from the interior of the bag to be led to the one way valve device. The one way valve device is made of a composition that remembers its original form, the form of the device having at least two component arms that meet with a sealing male and female format that separates and opens to allow any and all of the air from the interior of the bag to be released through the use of human applied pressure against the bag flexible structure, thereby evacuating the air from the interior of the bag. Upon release of the applied pressure the at least two component or component arms close and seal the bag preventing any additional air from reentering the bag through the one way valve device and thereby protecting the bag's contents from the destruction of its food contents or any other kind of stored contents for which air has a harming effect on it.

### FIELD OF THE INVENTION

The present invention relates generally to valves for removal of air from food storage bags or containers and, more particularly, to a one way valve where when pressure is applied, the one way valve is opened to evacuate air from the container and when the applied pressure is removed, the one way valve automatically closes preventing air from entering or leaving the container.

### BACKGROUND OF THE INVENTION

A container, such as a flexible plastic bag, is often used as a receptacle to store food. To provide optimum storage conditions, it is often desirable for air to be removed from the container. One methodology for the optimization of food storage is by the use of a procedure to evacuate the air within the storage bags prior to storage. This allows food, within the storage area of the bag, to be preserved for an extensive time period in a more hygienic manner, and through an inexpensive manufacturing process provide its users with a greater expediency and ease for maintaining the foods original basis. In the present invention, a one way valve is provided to exhale or evacuate air from the container or storage bag used in storing various items that benefit from the lack of destructed air within the bag structure and its ability in maintaining the bag's contents in a preserved state.

### SUMMARY OF THE INVENTION

The present invention provides for a one way valve to evacuate air from a container, particularly, a food storage container, for improved storage conditions. The one way valve of the present invention is comprised of a casing above an opening in the container and having an aperture allowing for the passage of the air from the interior of the bag to the exterior of the bag. The base of the casing is permanently sealed to the exterior surface of the storage container. The one way valve is operated by applying pressure to the storage container thereby forcing the one way valve to open allowing air to be forced to the exterior of the container. The casing of the present invention has a resolute memory quality which allows the one way valve device to automatically close upon the user's release of the pressure application.

These and other features of the invention are fully described and particularly pointed out in the claims. The following description and drawings set forth in detail certain illustrative embodiments of the invention which are indicative of but a few of the various ways in which the principles of the invention may be employed.

### BRIEF DESCRIPTION OF DRAWINGS

FIG. 1 illustrates a perspective view of the one way valve attached to the exterior surface of the storage bag.

FIG. 2(a) shows a top view of a food storage bag having the one way valve attached to the exterior surface of the storage bag.

FIG. 2(b) shows a cross sectional view of a food storage bag having the one way valve attached to the exterior surface of the storage bag.

FIG. 3(a) illustrates a cross sectional view of an embodiment of the one way valve in the closed position wherein the aperture is in a slit configuration.

FIG. 3(b) illustrates a cross sectional view of an embodiment of the one way valve in the open position wherein the aperture is in a slit configuration.

FIG. 4(a) illustrates a cross sectional view of an embodiment of the one way valve in the closed position wherein the aperture is in a labyrinth configuration.

FIG. 4(b) illustrates a cross sectional view of an embodiment of the one way valve in the open position wherein the aperture is in a labyrinth configuration.

FIG. 5(a) illustrates a perspective and partially bottom view of an embodiment of the one way valve wherein the casing is rectilinear in shape.

FIG. 5(b) illustrates a side view of an embodiment of the one way valve wherein the casing is rectilinear in shape.

FIG. 5(c) illustrates a top view of an embodiment of the one way valve wherein the casing is rectilinear in shape.

FIG. 5(d) illustrates a cross sectional view of an embodiment of the one way valve wherein the casing is rectilinear in shape and the aperture is in a labyrinth configuration.

FIG. 6(a) illustrates a perspective and partially bottom view of an embodiment of the one way valve wherein the casing is rectilinear in shape.

FIG. 6(b) illustrates a side view of an embodiment of the one way valve wherein the casing is rectilinear in shape.

FIG. 6(c) illustrates a top view of an embodiment of the one way valve wherein the casing is rectilinear in shape and the aperture is in a C or semi circular configuration.

FIG. 7(a) illustrates a perspective and partially bottom view of an embodiment of the one way valve wherein the casing is rectilinear in shape.

FIG. 7(b) illustrates a side view of an embodiment of the one way valve wherein the casing is rectilinear in shape.

FIG. 7(c) illustrates a top view of an embodiment of the one way valve wherein the casing is rectilinear in shape and the aperture is in a X configuration.

FIG. 8(a) illustrates a perspective and partially bottom view of an embodiment of the one way valve wherein the casing is round in shape.

FIG. 8(b) illustrates a side view of an embodiment of the one way valve wherein the casing is round in shape.

FIG. 8(c) illustrates a top view of an embodiment of the one way valve wherein the casing is round in shape.

FIG. 8(d) illustrates a cross sectional view of an embodiment of the one way valve wherein the casing is round in shape and the aperture is in a labyrinth configuration.

FIG. 9(a) illustrates a perspective and partially bottom view of an embodiment of the one way valve wherein the casing is round in shape.

FIG. 9(b) illustrates a side view of an embodiment of the one way valve wherein the casing is round in shape.

FIG. 9(c) illustrates a top view of an embodiment of the one way valve wherein the casing is round in shape and the aperture is in a C or semi circular configuration.

FIG. 10(a) illustrates a perspective and partially bottom view of an embodiment of the one way valve wherein the casing is round in shape.

FIG. 10(b) illustrates a side view of an embodiment of the one way valve wherein the casing is round in shape.

FIG. 10(c) illustrates a top view of an embodiment of the one way valve wherein the casing is round in shape and the aperture is in an X configuration.

FIG. 11(a) illustrates a top view of an embodiment of the one way valve attached to the exterior surface of the storage bag.

FIG. 11(b) illustrates a top view of an embodiment of the one way valve wherein the one way valve is in a sleeve configuration and in the open position.

FIG. 11(c) illustrates a top view of an embodiment of the one way valve wherein the one way valve is in a sleeve configuration and in the closed position.

FIG. 12(a) illustrates a top view of an embodiment of the one way valve wherein the valve is rectilinear in shape and possesses a cap that fits over the exterior of the one way valve to ensure the one way valve remains in the closed position.

FIG. 12(b) illustrates a perspective view of an embodiment of the one way valve showing how the cap fits over the exterior of the one way valve.

FIG. 12(c) illustrates a side view of an embodiment showing how the cap fits over the exterior of the one way valve and has a handle for the user to place the cap onto the one way valve.

FIG. 12(d) illustrates a front view of an embodiment showing how the cap fits over the exterior of the one way valve.

### DETAILED DESCRIPTION OF THE DRAWINGS

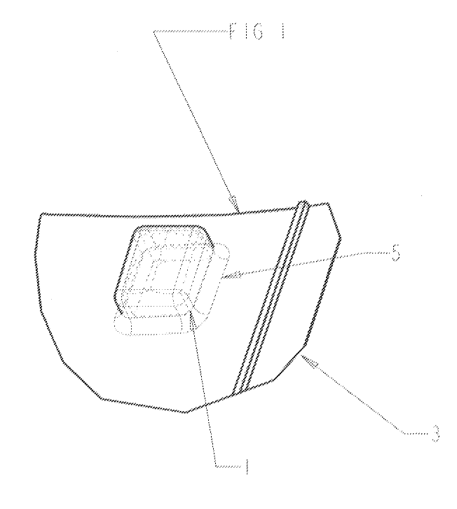

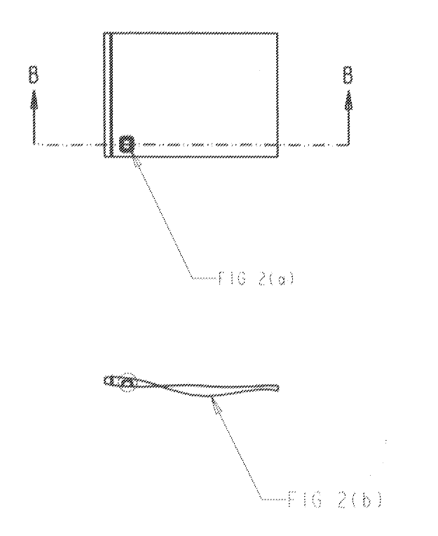

As shown in FIG. 1 and FIG. 2(a), the one way valve 1 is attached to the outer surface 3 of a plastic storage bag in the portion of the bag proximate to but below the closure of the plastic storage bag. The one way valve 1 may be attached on any portion of the outer surface 3 of the container or bag below the closure of the storage bag. FIG. 2(b) illustrates a side view of the one way valve 1 in position on the surface of the bag. In the case of food, which is normally a fragile storage product, it can be anticipated that the present invention can facilitate the majority of food merchandise bags presently in the market place in extracting the necessary air from within the bag structure.

The one way valve 1 is created by sonic sealing the base 5 to the bag's plastic surface and simultaneously creating the hole in the bag's plastic material allowing for passage of the air from the interior of the bag to the exterior of the bag. In a preferred embodiment, the one way valve 1 is centered over an opening 7 in the storage bag to allow air to flow from the interior of the storage bag in to the cavity 9 of the casing 11.

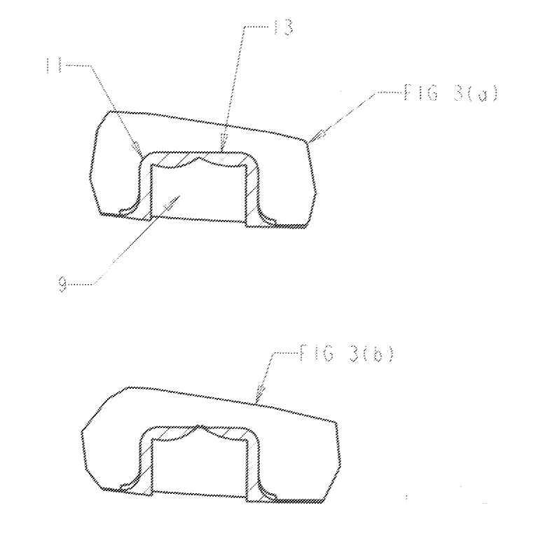

In one embodiment of the present invention illustrated in FIG. 3(a), the casing 11 of the one way valve possesses a top portion 13. The top portion 13 of the one way valve 1 may be comprised of at least two components 15 and 17 or component arms which are located at a predetermined height from the base 5 and located in a plane above the outer surface 3 of the bag.

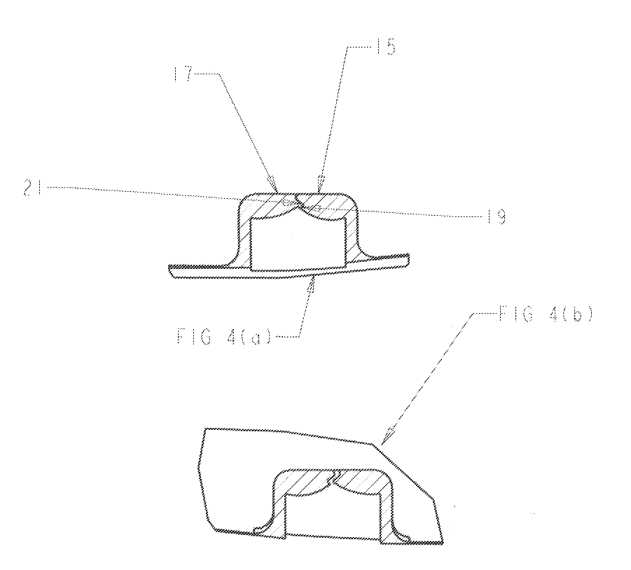

As illustrated in FIGS. 3(a) and 4(a), the one way valve 1 is shown in a closed operating position wherein the at least two components 15 and 17 or component arms meet or “lock” to prevent any air from entering the interior of the bag. The casing 11 including the top portion 13 is made of a material with a predetermined memory in its design. When a predetermined amount of pressure is applied to the outer surface 3 of the storage bag, the at least two components 15 and 17 “unlock” and move away from the other components toward the exterior to form an aperture whereby air is evacuated from the interior of the bag to the exterior of the bag. This pressure force quotient is a product of the design and the material used. FIGS. 3(b) and 4(b) illustrate the one way valve 1 in the open position where an aperture is formed when the at least two components 15 and 17 have moved away from each other thereby causing an opening from the interior of the storage bag to the exterior from which air is forced out.

The operation of the one way valve 1 therefore only requires that the operator simply apply pressure against the outer surface 3 of the storage bag to exhale or remove the air out of the interior portion of the bag to provide a large degree of a germ-free, air free inner environment. Due to the resolute memory quality of the one way valve 1, the one way valve 1 will simply close upon the user's release of the pressure application. The one way valve 1 valve thereby automatically closes and prevents air return into the interior of the storage bag thus accomplishing the goal of preserving the contents in an air free environment. The at least two components 15 and 17 or component arms have male and female closure features at their joining and or meeting points 19 and 20 which enhances the power of the one way valve 1 in the closed position. As shown in FIG. 3(a), the aperture may be a straight sealed closure configuration wherein the male and female closure features 19 and 21 are flush against each other in the closed position.

One of the key advantages of the present invention over the prior art is that the design of the one way valve 1 provides for simplicity of use. The user simply needs only to release pressure on the outer surface 3 of the storage bag to “close” the one way valve 1. The design of the one way valve 1 allows the valve to automatically close upon release of pressure by the user and therefore does not require affirmative or additional steps by the user as is required by the prior art. Further, an advantage of the present invention over the prior art is that the one way valve 1 does not require any additional adhesive or components to remain in the closed position thereby reducing the cost of manufacture and increasing the simplicity of use.

FIG. 4(a) and FIG. 4(b) depict a labyrinth design closure which accomplishes the same function of preserving the contents in an air free environment. Alternatively, the design of the closure of the one way valve 1 may be any conventional closure or shape capable of accomplishing the same one way valve mechanism such as curved, stepped or angled.

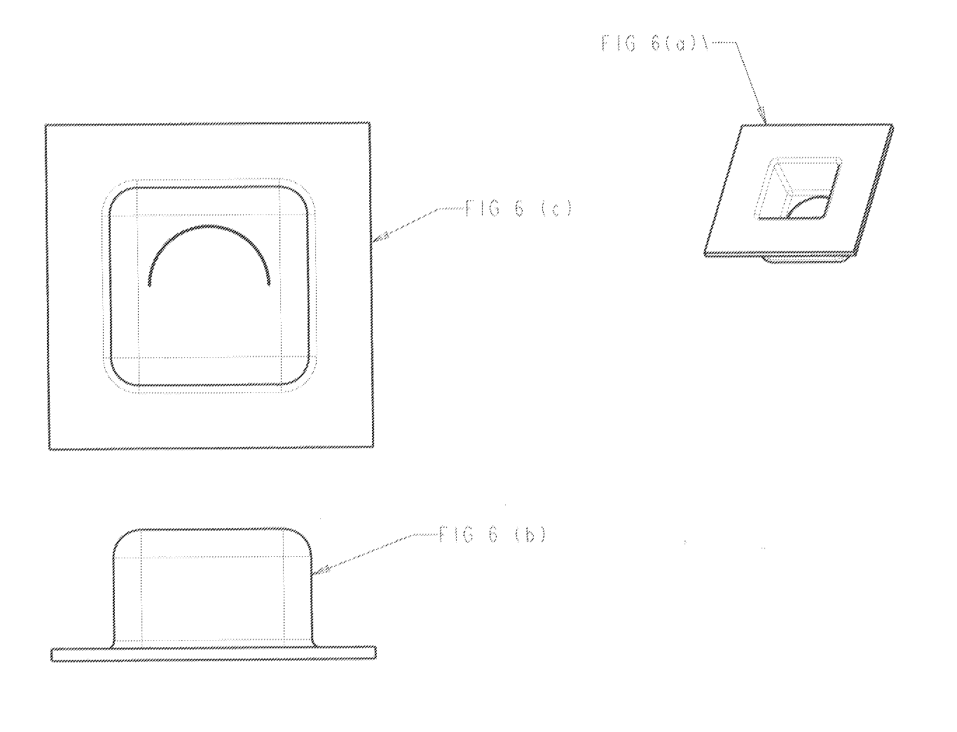

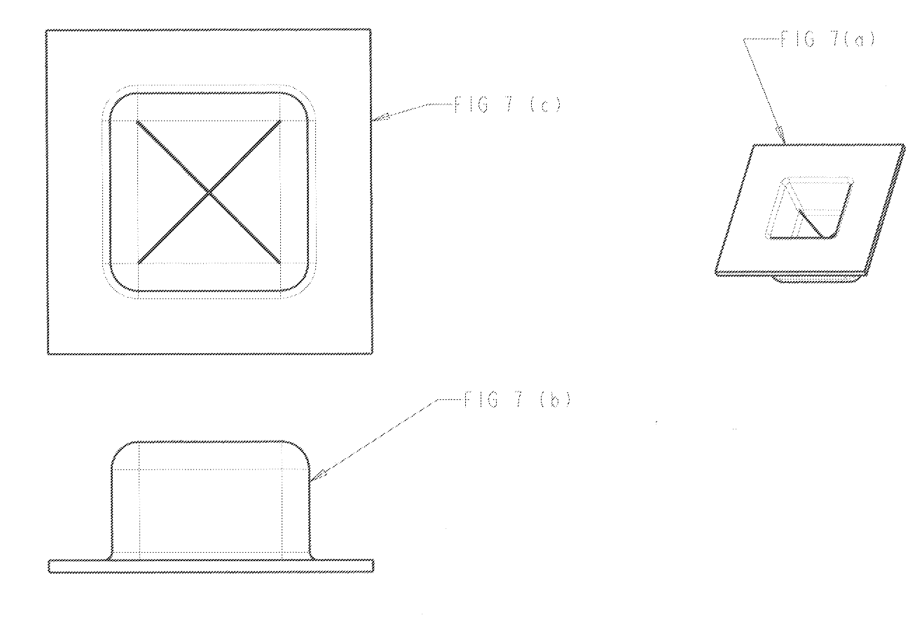

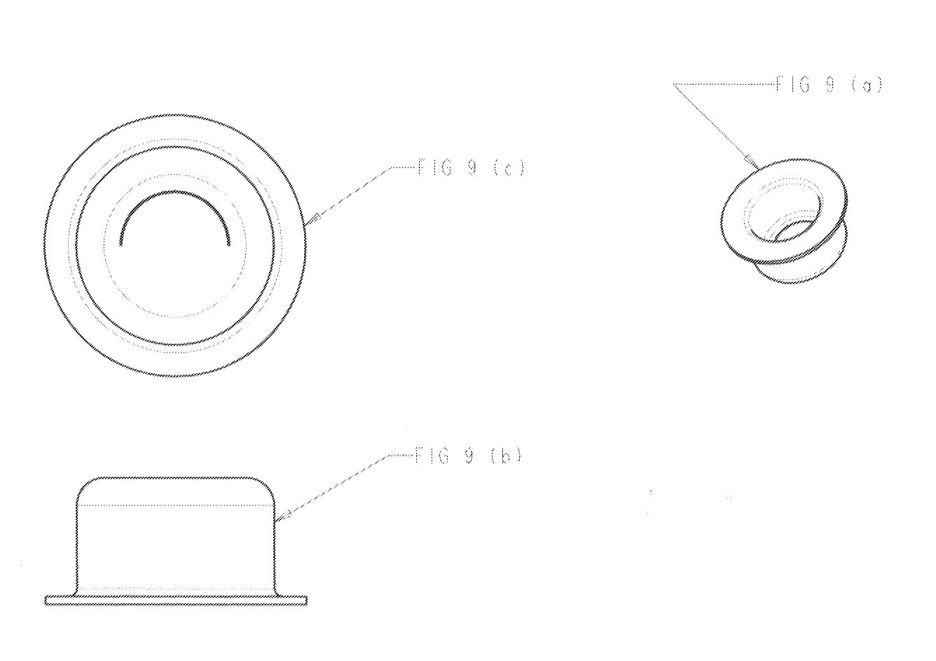

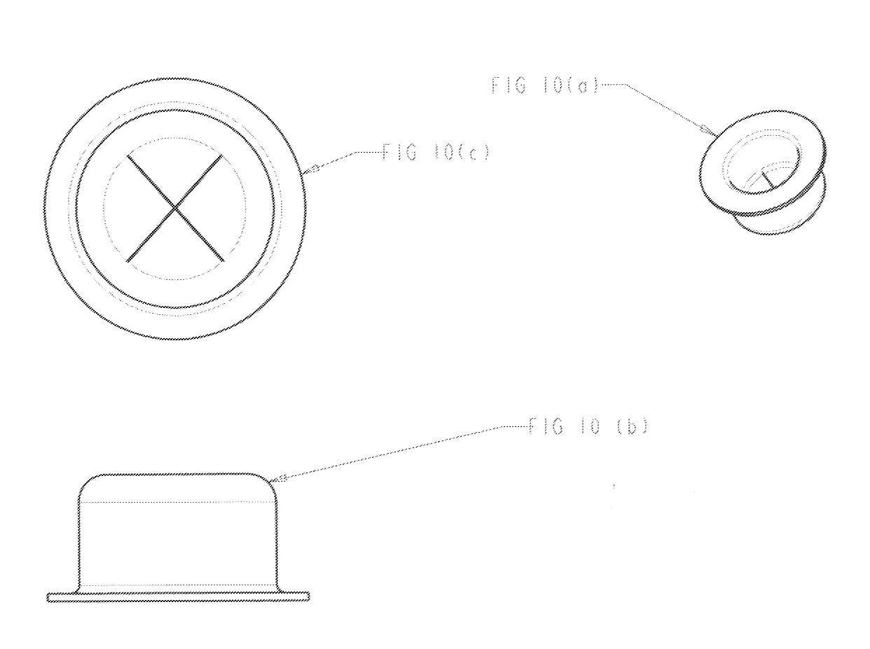

As shown in FIGS. 6(a)-(c) and FIGS. 9(a)-(c), the configuration of the closure may be C or semi circular in shape. As shown in FIGS. 7(a)-(c) and FIGS. 10(a)-(c), the configuration of the aperture or closure may be comprised of two intersecting lines resembling an “X” in shape. The configuration of the aperture or closure of the one way valve 1 may be any conventional closure or shape capable of accomplishing the same one way valve mechanism such as curved, stepped or angled in profile.

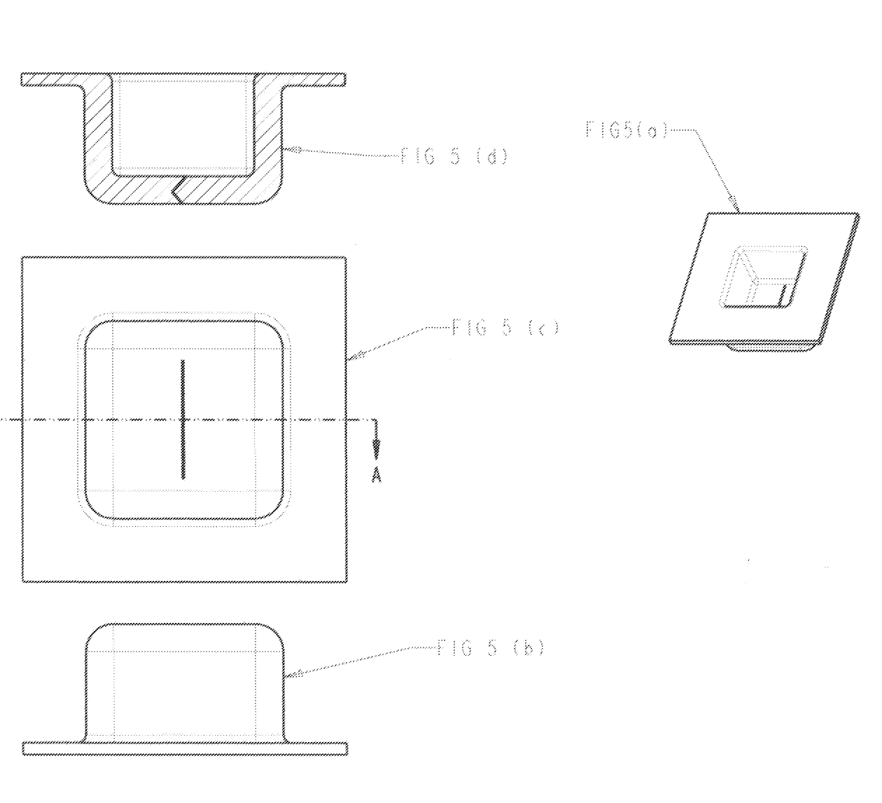

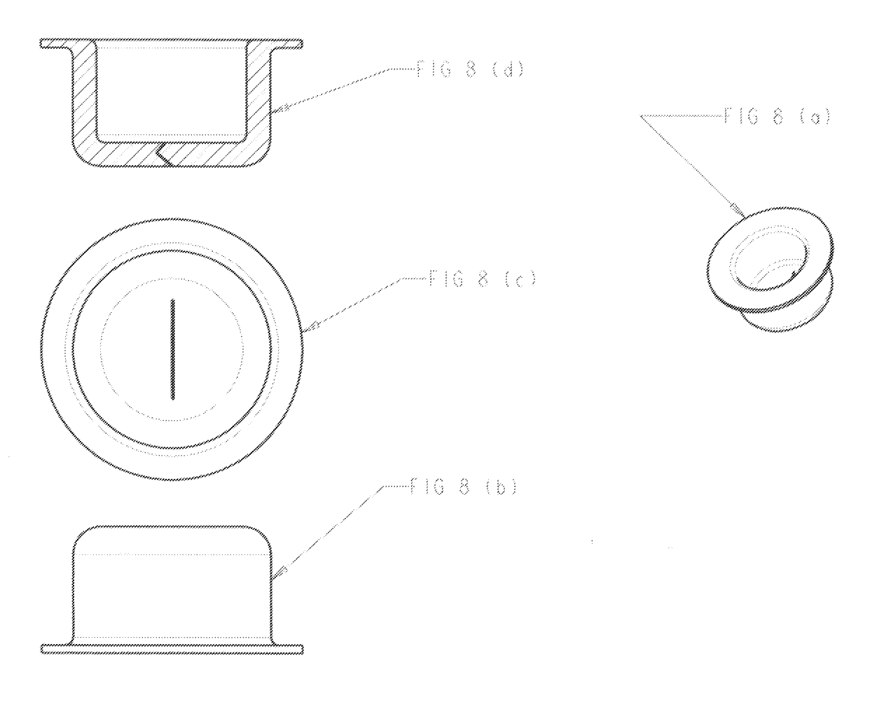

The one way valve 1 may be any conventional shape such as circular, elliptical or triangular. FIGS. 5(a)-(d) through 7(a)-(c) illustrate the one way valve 1 in a rectilinear shape. Alternatively, FIGS. 8(a)-(d) through 10(a)-(c) illustrate the one way valve 1 in a circular or round shape.

In the present invention, the top portion 13 and male and female closure features 19 and 21 may vary in height from the base 5 and the outer surface 3 of the container or bag. In one embodiment, the male and female closure features 19 and 21 may be in the same plane as the outer surface 3 of the container or bag. Alternatively, the male and female closure features 19 and 21 may be in a plane below the outer surface 3 of the container or bag and extend into the interior of the container or bag.

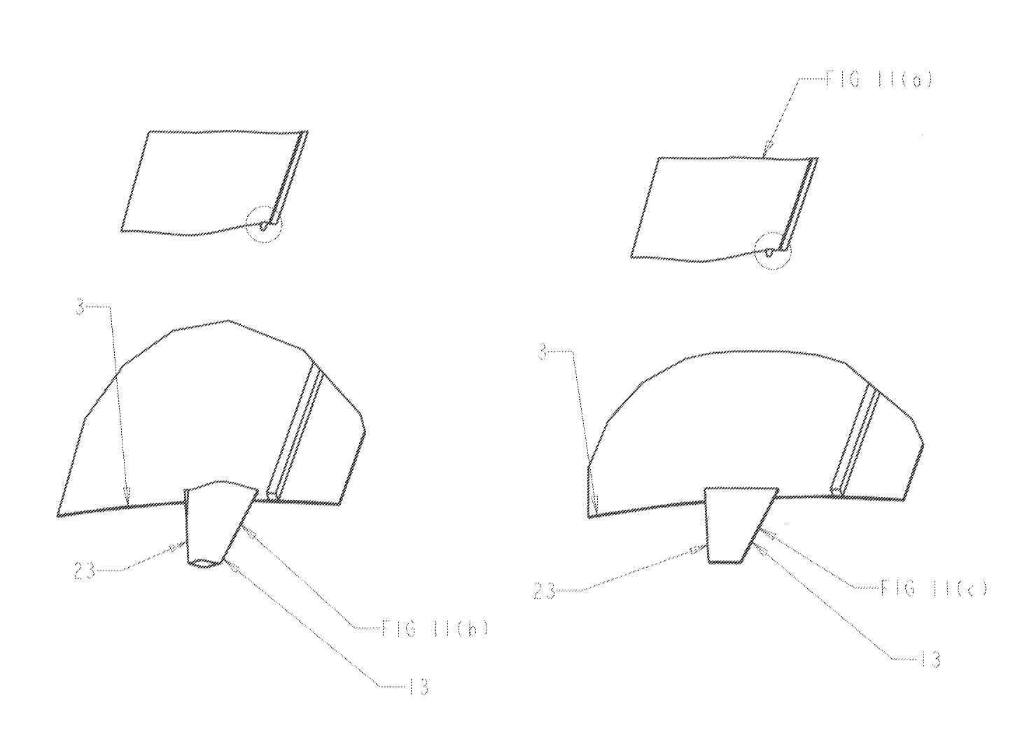

In an embodiment of the present invention, as illustrated in FIG. 11(a), the top portion 13 is comprised of a sleeve 23 that extends axially from the outer surface 3 of the storage bag at one end of the sleeve and is open to the exterior at the opposite end. When a predetermined amount of pressure is applied to the outer surface 3 of the storage bag, the sleeve 23 creates a passageway to the exterior whereby air is evacuated from the interior of the bag to the exterior of the bag. FIG. 11(b) shows the present embodiment in the open position. When the user releases, the sleeve 23 collapses the passageway thereby closing the opening at the one end of the sleeve to the exterior as shown in FIG. 11(c).

In a preferred embodiment of the present invention, the one way valve 1 is manufactured using a polymer with a memory such as olefin block copolymers. The use of such a polymer allows the one way valve 1 to be opened upon application of pressure and to be closed with release of such pressure. Further, the use of such olefin block copolymers allows the one way valve 1 to remain closed without the need for any additional components or adhesives. The use of the special polymer is another key advantage of the present invention over the prior art because it allows for reduced cost of manufacture and increased simplicity of use.

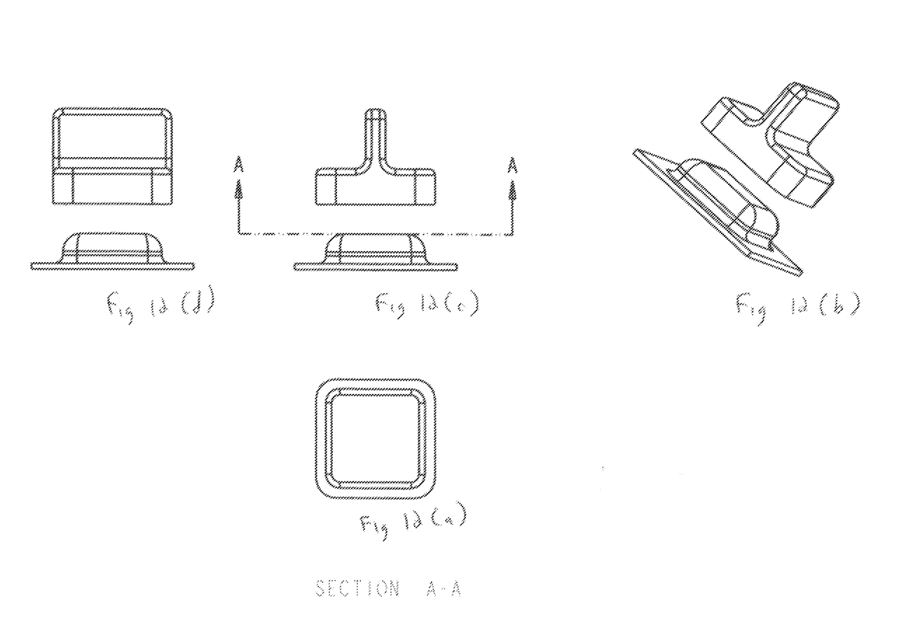

In a preferred embodiment of the present invention, as shown in FIGS. 12(a)-(d), the one way valve 1 may have a detachable cap or cover that covers the top portion 13 and the male and female closure features 19 and 21. The cap will have the same shape as the one way valve 1 to provide a secure fit. Further, the cap will have an inner diameter or perimeter that corresponds to the outer diameter or perimeter of the one way valve to provide a snug fit. The advantage of the use of the cap is to prevent the opening of the one way valve 1 by inadvertent pressure applied to the outer surface 3 of the storage bag when such bag is stacked with other items in the refrigerator or freezer. In a preferred embodiment, the exterior surface of the one way valve 1 may be recessed or beveled with a corresponding ridge on the inner surface of the cap such that when the cap is placed on to the one way valve 1 the cap is locked or secured into place. Such male and female closure features may enhance the ability of the one way valve 1 to be locked into the closed position to prevent air from entering the one way valve 1.

Although the disclosure has primarily described the applicability of the one way valve 1 for food storage bags, the one way valve 1 also has significant applicability in the areas of medical sterilization containers and clothing storage containers. In the medical field, the one way valve 1 allows users to prevent air from entering or exiting the container once the contents of the container have been sterilized to ensure the continued sterility of the contents. In the clothing storage field, the one way valve 1 allows users the ease of evacuating air from the interior of the container by simply depressing the outer surface of the container thereby obviating the need of a vacuum device.

One of the significant advantages of the present invention over the prior art is that the one way valve 1 does not require the use of any adhesive to remain in the closed position. The design of the one way valve 1 allows the valve to automatically close upon release of pressure by the user and therefore does not require affirmative or additional steps by the user as is required by the prior art.

Simplistic ease of manufacturing and effortless application of this one way valve 1 are significant improvements of the present invention over the prior art. The small size and compact design of the one way valve 1 and use of inexpensive polymers allows for reduced manufacturing costs. The present invention is further designed to maintain its opening and closing functionality with minimal effort by the user. The manufacturing costs of the one way valve 1 is being extremely inexpensive in relationship to its purpose of reducing food spoilage thereby creating a greater economical value to the user and user's household through the reduction of spoiled food and the corresponding minimization of bacterial exposure in the process of food consumption.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments.

We hereby claim:

1. A one way valve to evacuate air from a container comprising a casing having a base that is permanently sealed to the exterior surface of a container wherein the casing is located above an opening in the container and having an aperture allowing for the passage of the air from the interior of the bag to the exterior of the bag.

2. A one way valve according to claim 1, wherein the valve has a top portion having at least 2 components or component arms which are located at a predetermined height from the base and located in a plane above the outer surface of the bag which meet or lock to prevent any air from entering the interior of the bag.

3. A one way valve according to claim 1 wherein the one way valve is manufactured using a polymer with a memory such as olefin block copolymers

4. A one way valve according to claim 1 wherein the one way valve is rectilinear in shape.

5. A one way valve according to claim 1 wherein the one way valve is round in shape.

6. A one way valve according to claim 1 wherein the one way valve is elliptical in shape.

7. A one way valve according to claim 2 wherein the at least two components or component arms form a labyrinth configuration when in the closed position.

8. A one way valve according to claim 2 wherein the at least two components or component arms form a C configuration when in the closed position.

9. A one way valve according to claim 2 wherein the at least two components or component arms form a straight seal configuration when in the closed position.

10. A one way valve according to claim 2 wherein the at least two components or component arms form an X configuration when in the closed position.

11. A one way valve according to claim 2 wherein the one way valve possesses a detachable cap that covers the top portion and the at least two components or component arms.

12. A one way valve according to claim 2 wherein the top portion is comprised of a sleeve that extends axially from the outer surface of the storage bag at one end of the sleeve and is open to the exterior at the opposite end.

13. A one way valve to evacuate air from a container manufactured using a polymer with a memory such as olefin block copolymers allowing the one way valve to remain closed.

14. A method for creating a one way valve for evacuating air from a container including the steps of sonic sealing the base of a casing made of a polymer with a memory such as olefin block polymers to a container's outer surface and simultaneously creating an opening in the container for passage of the air from the interior of the container to the exterior of the container.

15. A method for evacuating air from a container including the steps of sonic sealing the base of a casing made of a polymer with a memory such as olefin block polymers to a container's outer surface and simultaneously creating an opening in the container for passage of the air from the interior of the container to the exterior of the container.
